(19) United States
(12) Patent Application Publication
(10) Pub. No.: US 2002/0146025 A1
(43) Pub. Date: Oct. 10, 2002

(54) Arbiter device for multi-port memory and semiconductor device

(76) Inventor: Katsumi Okina, Tokyo-To (JP)

Correspondence Address: HOGAN & HARTSON L.L.P., 500 S. GRAND AVENUE, SUITE 1900, LOS ANGELES, CA, 90071-2611, US

(21) Appl. No.: 10/041,726

(22) Filed: Jan. 7, 2002

(30) Foreign Application Priority Data
Jan. 26, 2001 (JP) 2001-019028(P)

(51) Int. Cl. H04L 12/54

(52) U.S. Cl. 370/428

(57) ABSTRACT

An arbiter device for a multi-port memory is provided that includes an identical address detection circuit, an OR gate circuit, a D-type flip-flop, a buffer, and a selector. The identical address detection circuit can detect if input addresses to two ports of a multi-port memory are identical with each other. The selector outputs output data on the write port and output data on the read port. When an input address to the A port of the multi-port memory is identical with an input address to the B port thereof, the operation of the B port is stopped, and data on the A port is selected and output, such that simultaneous accesses to the same address can be made. As such, an arbiter device for a multi-port memory can be provided that enables simultaneous accesses to the same address when an input address to a first port of a multi-port memory and an input address to a second port of the multi-port memory are identical.

### BACKGROUND OF THE INVENTION

The present invention relates to an arbiter device for a multi-port memory and a semiconductor device.

Conventionally, multi-port memories having a plurality of accessible ports can suffer from a variety of drawbacks. For example, in conventional multi-port memories, when accesses to the same address are made simultaneously attempted at a plurality of ports, such accesses fail and data may not be secured.

As a result, in conventional multi-port memories, a program for an external circuit and a Central Processing Unit (CPU) is typically utilized such that simultaneous accesses to the same address are not allowed by a plurality of ports of the multi-port memory.

### SUMMARY OF THE PREFERRED EMBODIMENTS

An aspect of the present invention provides an arbiter device for a multi-port memory equipped with a first port and a second port that includes an identical address detection device, an operation stopping device, and a selector device. The identical address detection device determines whether an input address to the first port and an input address to the second port are identical. The operation stopping device stops operation of the second port of the multi-port memory when the identical address detection device determines that the input address to the first port and the input address to the second port are identical. The selector device selects data and outputs data on the first port of the multi-port memory when the identical address detection device determines that the input address to the first port and the input address to the second port are identical.

Another aspect of the present invention provides an arbiter device for a multi-port memory equipped with a write-only first port and a read-only second port that includes an identical address detection device, an operation stopping device, and a selector device. The identical address detection device determines whether an input address to the write-only first port and an input address to the read-only second port are identical. The operation stopping device stops operation of the read-only second port of the multi-port memory when the identical address detection device determines that the input address to the write-only first port and the input address to the read-only second port are identical. The selector device selects data and outputs data on the write-only first port of the multi-port memory when the identical address detection device determines that the input address to the write-only first port and the input address to the read-only second port are identical.

Another aspect of the present invention provides an arbiter device for a multi-port memory equipped with a readable and writeable first port and a read-only second port that includes an identical address detection device, an operation stopping device, and a selector device. The identical address detection device determines whether an input address to the readable and writeable first port and an input address to the read-only second port are identical, and a writing operation to the first port is enabled. The operation stopping device stops operation of the read-only second port of the multi-port memory when the identical address detection device determines that the input address to the readable and writeable first port and the input address to the read-only second port are identical, and a writing operation to the first port is enabled. The selector device selects data and outputs data on the readable and writeable first port of the multi-port memory when the identical address detection device determines that the input address to the readable and writeable first port and the input address to the read-only second port are identical, and a writing operation to the first port is enabled.

Each arbiter device described above can be integrated into an integrated circuit and/or semiconductor device.

### BRIEF DESCRIPTION OF DRAWINGS

The following discussion may be best understood with reference to the various views of the drawings, described in summary below, which form a part of this disclosure.

FIG. 1 shows an example of a structure of an arbiter device for a multi-port memory in accordance with a preferred aspect of the present invention.

FIG. 2 shows a timing chart of the arbiter device for a multi-port memory in accordance with a preferred aspect of the present invention.

FIG. 3 shows another example of a structure of an arbiter device for a multi-port memory in accordance with a preferred aspect of the present invention.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout. It will also be understood that when an element such as a block, circuit, circuit component and/or device is referred to as being “connected to” another element, it can be directly connected to the other element or intervening elements may also be present. In contrast, when an element is referred to as being “directly connected to” another element, there are no intervening elements present. When an element such as a block, circuit, circuit component and/or device is referred to as being “adjacent” another element, it can be near the other element but not necessarily independent of the other element. When an element such as a block, circuit, circuit component and/or device is referred to as being “between” two things, it can be either partly of completely between those two things, but is not necessarily completely and continuously between those two things. The term “adapted to” should be construed to mean “capable of”.

Aspects of the present invention can provide an arbiter device for a multi-port memory with a first port and a second port, for example, that can enable simultaneous accesses to an identical address by a plurality of ports of the multi-port memory. When an input address to a first port and an input address to a second port are identical with each other, the operation of the second port can be stopped, and data of the first port can be selected and output, such that simultaneous accesses to the identical address can be made.

Preferred implementations of the present invention can provide an arbiter device for a multi-port memory 101, 301 equipped with at least a first port and a second port. The arbiter device can include an identical address detection device 102, 302, an operation stopping device 107, 307, and a selector device.

In preferred implementations of the present invention, the identical address detection device 102, 302 can determine whether an input address to the first port and an input address to the second port are identical. The identical address detection device 102, 302 can be responsive to at least one of the input address to the first port and the input address to the second port. The identical address detection device 102, 302 can generate an identical address detection signal if the input address to the first port and the input address to the second port are identical. By contrast, if the input address to the first port and the input address to the second port are not identical, then the identical address detection device 102, 302 can generate a complement of the identical address detection signal. The arbiter device can thus arbitrate between accesses to the first port and the second port.

In preferred implementations of the present invention, the operation stopping device 107, 307 can stop operation of the second port of the multi-port memory 101, 301 when the identical address detection device determines that the input address to the first port and the input address to the second port are identical.

In preferred implementations of the present invention, the selector device 106, 306 can select data and output data on the first port of the multi-port memory when the identical address detection device determines that the input address to the first port and the input address to the second port are identical. The selector device 106, 306 can select data and output data on the second port of the multi-port memory when the identical address detection device determines that the input address to the first port and the input address to the second port are not identical. The selector device 106, 306 can be responsive to at least one of a data output signal of the first port, a data output signal of the second port, and a buffer output signal. The selector device 106, 306 can generate a data output signal.

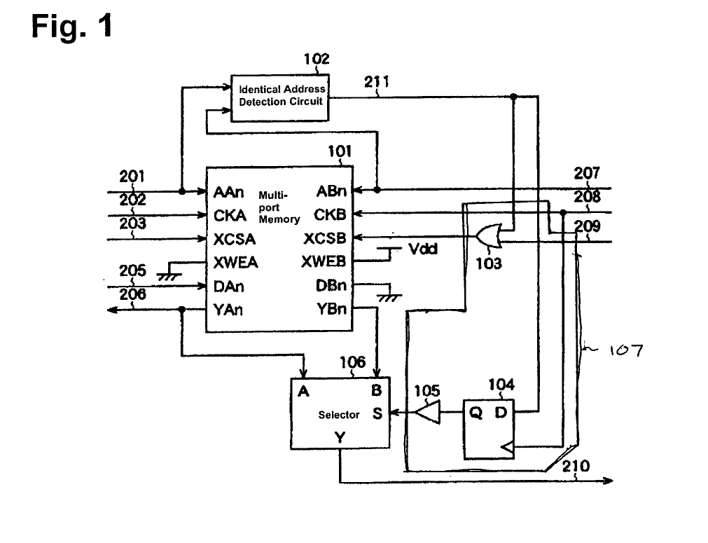

FIG. 1 schematically shows one example of an arbiter device for a multi-port memory in accordance with an aspect of the present invention. Referring to FIG. 1, the arbiter device can be equipped with an identical address detection circuit 102, an operation stopping device 107, and a selector 106. The identical address detection circuit 102 can detect if input addresses to two ports of a synchronized multi-port memory 101 are identical with one another. The operation stopping device 107 can include, for example, an OR gate circuit 103, a D-type flip-flop 104, a buffer 105 that adjusts hold of an output signal of the D-type flip-flop 104.

The multi-port memory 101 can be equipped, for example, with two ports, labeled as A port and B port. The A port of the multi-port memory 101 can be, for example, a write-only port and can include an address input terminal AAn, a clock input terminal CKA, a non-operation instruction input terminal XCSA, a write enable input terminal XWEA, a data input terminal DAn, and a data output terminal YAn. The B port of the multi-port memory 101 can be, for example, a read-only port and can include an address input terminal ABn, a clock input terminal CKB, a non-operation instruction input terminal XCSB, a write enable input terminal XWEB, a data input terminal DBn, and a data output terminal YBn.

The address input terminal AAn of the multi-port memory 101 can receive a write address from an external circuit through an address input line 201. The clock input terminal CKA can receive a clock signal from an external circuit through a clock input line 202. The non-operation instruction input terminal XCSA can receive a non-operation instruction from an external circuit through a non-operation instruction input line 203. The write enable input terminal XWEA can be an active low input terminal that can be grounded because in this example the A port is a write-only port. The data input terminal DAn receives write data from an external circuit through a data input line 205. The data output terminal YAn outputs the write data, that is input in the data input terminal Dan, to a data output line 206, because in this example the A port is a write-only port.

The address input terminal ABn of the multi-port memory 101 can receive a read address from an external circuit through an address input line 207. The clock input terminal CKB can receive a clock signal from an external circuit through a clock input line 208. The non-operation instruction input terminal XCSB can receive a non-operation instruction from the OR gate circuit 103. The write enable input terminal XWEB can be an active low input terminal. Because in this example the B port is a read-only port, the write enable input terminal XWEB is pulled up, and the data input terminal DBn is grounded. The data output terminal YBn can output data retained at an address that is input in the address input terminal ABn.

The identical address detection circuit 102 can receive a write address from the address input signal line 201 and a read address from the address input signal line 207, respectively. The identical address detection circuit 102 can output, for example, a signal at logic “H” to an identical address detection signal output line 211 when the write address and the read address are the same address. Also, the identical address detection circuit 102 can output, for example, a signal at logic “L” to the identical address detection signal output line 211 when the write address and the read address are not the same address.

The operation stopping device 107 is responsive to at least one of a signal from the identical address detection signal output line 211, a signal from the read clock input line 208, and a signal from a non-operation signal input line 209.

The operation stopping device 107 can generate non-operation instruction and a selector input signal.

Two input terminals of a two input OR gate circuit 103 are connected to a non-operation signal input line 209 and the identical address detection signal output line 211. The D-type flip-flop 104 has an input terminal that can be connected to the identical address detection signal output line 211. A clock input terminal of the D-type flip-flop 104 can be connected to the read clock input line 208. The buffer 105 has an input terminal that can be connected to an output terminal of the D-type flip-flop 104.

The selector 106 has an input terminal A that can be connected to the data output terminal YAn. Also, the selector 106 has an input terminal B that can be connected to the data output terminal YBn. Further, the selector 106 has an input terminal S that can be connected to an output terminal of the buffer 105. Also, the selector 106 has an output terminal Y that can be connected to the data output line 210. When the signal at logic “H” is input in the input terminal S, the selector 106 outputs data that is input in the input terminal B through the output terminal Y. When a signal at logic “L” is input in the input terminal S, the selector 106 outputs data that is input in the input terminal B through the output terminal Y.

Next, an operation of the arbiter device for a multi-port memory will be described.

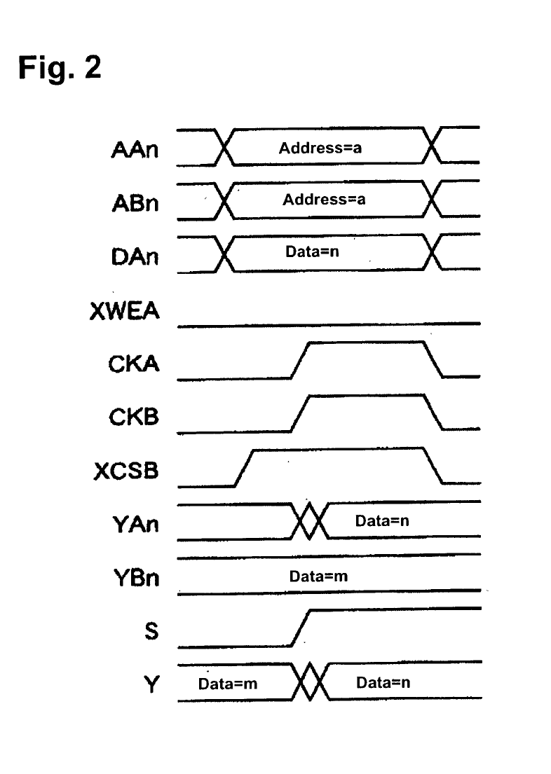

First, an operation that takes place when the write address on the address input line 201 and the read address on the address input line 207 are identical with each other will be described. FIG. 2 shows a timing chart concerning the circuitry, illustrated in FIG. 1.

Referring to FIG. 2, an address a can be input in the address input terminal AAn, and data n can be input in the data input terminal DAn. Further, the write enable input terminal XWEA is grounded. A clock signal can be input in the clock input terminal CKA. Accordingly, data n is written in the address a at the timing of a rising edge of the clock signal that is input in the clock input terminal CKA. Also, after a predetermined delay from the time when data n is written in the address a, data n that is input in the data input terminal DAn can be output from the data output terminal Yan.

On the other hand, an address a that is identical with the address a that is input in the address input terminal AAn can be input in the address input terminal ABn. As a result, the identical address detection circuit 102 outputs a signal at logic “H” to the identical address detection signal output line 211. Since one of the two input terminals of the OR gate circuit 103 is connected to the identical address detection signal output line 211, when the identical address detection circuit 102 outputs a signal at logic “H”, the signal at logic “H” can be input in the non-operation instruction input terminal XCSB. Therefore, although identical clocks with the same phase are input in the clock input terminal CKA and the clock input terminal CKB, the B port 101 does not operate. As a result, data m that can be read out by an immediately preceding read operation continues to be output from the data output terminal YBn.

Also, the D-type flip-flop 104 has an input terminal D that is connected to the identical address detection signal output line 211. As a result, a signal at logic “H” is output from an output terminal Q of the D-type flip-flop 104 at the timing of a rising edge of the clock signal that is input from the clock input line 208.

When the signal at logic “H” is input from the D-type flip-flop 104 in the input terminal of the buffer 105, the signal at logic “H” is input in the input terminal S of the selector 106. Accordingly, the selector 106 outputs data n, which is generated from the data output terminal YAn, from the output terminal Y.

Next, an operation will be described that takes place when a write address on the address input line 201 is different from a read address on the address input line 207. When a write address is different from a read address, the identical address detection circuit 102 outputs a signal at logic “L” to the identical address detection signal output line 211. As a result, a predetermined read operation is conducted at the B port. The signal at logic “L” that is output from the identical address detection circuit 102 is also input in the input terminal S of the selector 106 through the D-type flip-flop 104 and the buffer 105. As a result, the output terminal Y of the selector 106 outputs read data that is output onto the data output terminal YBn of the B port where the predetermined read operation is conducted.

The arbiter device for a multi-port memory in accordance with one aspect of the present invention is described above. It will be appreciated that the multi-port memory 101, the identical address detection circuit 102, and the operatum stopping device 107 including the OR gate circuit 103, the D-type flip-flop 104, the buffer 105 and the selector 106 can be realized as a semiconductor device.

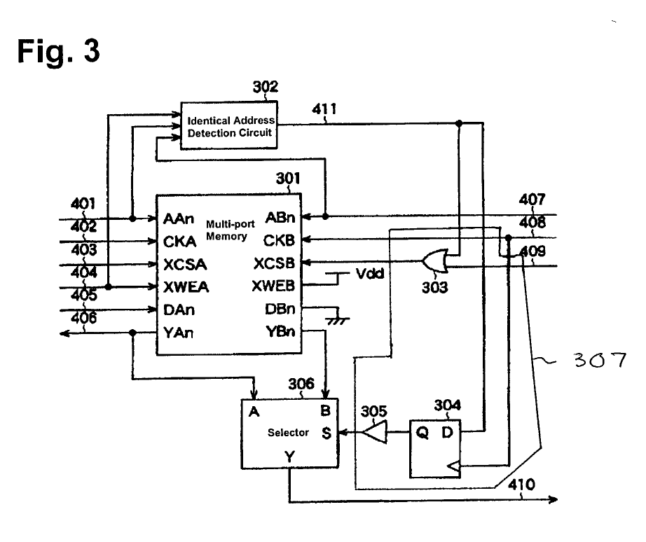

FIG. 3 schematically shows an example in which an arbiter device applied to a multi-port memory with three ports (one read/write port, one read port). It will be appreciated that the arbiter device could easily be implemented in a multi-port memory with more than those ports.

Referring to FIG. 3, the arbiter device for a multi-port memory can be equipped with an identical address detection circuit 202 that detects if input addresses to a perfectly synchronized multi-port memory 301 are identical with one another; an operation stopping device 107 that can include, for example, an OR gate circuit 203, a D-type flip-flop 204, a buffer 205 that adjusts hold of an output signal of the D-type flip-flop 204, and a selector 206.

The multi-port memory 301 can be equipped with an A port and a B port. The A port can be a read/write port, and can include an address input terminal AAn, a clock input terminal CKA, a non-operation instruction input terminal XCSA, a write enable input terminal XWEA, a data input terminal DAn, and a data output terminal YAn. The B port can be a read-only port that includes, for example, an address input terminal ABn, a clock input terminal CKB, a non-operation instruction input terminal XCSB, a write enable input terminal XWEB, a data input terminal DBn, and a data output terminal YBn.

The address input terminal AAn of the multi-port memory 301 can receive a read/write address from an external circuit through an address input line 401. The clock input terminal CKA can receive a clock signal from an external circuit through a clock input line 402. The non-operation instruction input terminal XCSA can receive a non-operation instruction signal from an external circuit through a non-operation instruction input line 403. The write enable input terminal XWEA can receive a write enable signal from an external circuit through a write enable input line 404. The data input terminal DAn can receive write data from an external circuit through a data input line 405. The data output terminal YAn can output the write data that is input in the data input terminal DAn to a data output line 406 in the case of a writing operation. The data output terminal YAn can output data that is retained at an address input in the address input terminal AAn to the data output line 406 at the time of a reading operation.

The address input terminal ABn of the multi-port memory 301 can receive a read address from an external circuit through an address input line 407. The clock input terminal CKB can receive a clock signal from an external circuit through a clock input line 408. The non-operation instruction input terminal XCSB can receive a non-operation instruction signal from the OR gate circuit 303. The write enable input terminal XWEB can be an active low input terminal, and can be pulled up in this example and the data input terminal DBn can be grounded because in this example, the B port is a read-only port. The data output terminal YBn outputs data retained at an address that is input in the address input terminal ABn.

The identical address detection circuit 302 can receive a write address from the address input signal line 401, a read address from the address input signal line 407, and a write enable signal from a write enable input line 404, respectively. The identical address detection circuit 302 can output a signal at logic “H” to an identical address detection signal output line 411 when the write address and the read address are the same address, and the write enable signal is active. The identical address detection circuit 302 can output a signal at logic “L” to the identical address detection signal output line 411 in the other cases.

The operation stopping device 107 is responsive to at least one of a signal from the identical address detection signal output line 211, a signal from the read clock input line 208, and a signal from a non-operation signal input line 209.

The operation stopping device 107 can generate non-operation instruction and a selector input signal.

In the two input OR gate circuit 303, the two input terminals can be connected to a non-operation signal input line 409 and the identical address detection signal output line 411. The D-type flip-flop 304 has an input terminal that can be connected to the identical address detection signal output line 411. A clock input terminal of the D-type flip-flop 304 can be connected to the read clock input line 408. The buffer 305 has an input terminal that can be connected to an output terminal of the D-type flip-flop 304.

The selector 306 has an input terminal A that can be connected to the data output terminal YAn and an input terminal B that can be connected to the data output terminal Ybn. The selector 306 also has an input terminal S that can be connected to an output terminal of the buffer 305. The selector 306 also has an output terminal Y that can be connected to the data output line 410. When a signal at logic “H” is input in the input terminal S, the selector 306 outputs data that is input in the input terminal A through the output terminal Y. By contrast, when a signal at logic “L” can be input in the input terminal S, the selector 306 outputs data that is input in the input terminal B through the output terminal Y.

Next, operation of the arbiter device for a multi-port memory will be described.

First, an operation will be described that takes place when the write address on the address input line 401 and the read address on the address input line 407 are identical and the signal on the write enable input line 404 is then enabled.

When the write address on the address input line 401 and the read address on the address input line 407 are identical and the signal on the write enable input line 404 is enabled, the identical address detection circuit 302 outputs a signal at logic “H” to the identical address detection signal output line 411.

Since one of the two input terminals of the OR gate circuit 303 is connected to the identical address detection signal output line 411, when the identical address detection circuit 302 outputs a signal at logic “H”, the signal at logic “H” is input in the non-operation instruction input terminal XCSB. Accordingly, the B port does not operate.

Also, the input terminal D of the D-type flip-flop 304 can be connected to the identical address detection signal output line 411. As a result, the output terminal Q of the D-type flip-flop 304 outputs a signal at logic “H” at the timing of a rising edge of the clock signal that is input from the clock input line 408.

When the signal at logic “H” is input from the D-type flip-flop 304 in the input terminal of the buffer 305, the signal at logic “H” is input in the input terminal S of the selector 306. Accordingly, the selector 306 outputs data n, which can be generated from the data output terminal YAn, from the output terminal Y.

Next, an operation will be described that takes place when a write address on the address input line 401 is different from a read address on the address input line 407, or a signal on the write enable signal line 404 is disabled.

In this case, the identical address detection circuit 302 outputs a signal at logic “L” to the identical address detection signal output line 411. As a result, a predetermined read operation can be conducted at the B port. Also, the signal at logic “L” that is output from the identical address detection circuit 302 is input in the input terminal S of the selector 306 through the D-type flip-flop 304 and the buffer 305. As a result, the output terminal Y of the selector 306 outputs read data that is output onto the data output terminal YBn of the B port where the predetermined read operation is conducted.

The arbiter device for a multi-port memory in accordance with an aspect of the present invention is described above. The arbiter device for a multi-port memory can be similarly applied to a multi-port memory with four ports (two read/write ports) or more.

Also, the multi-port memory 301, the identical address detection circuit 302, and the operation stopping device 307 including, for example, the OR gate circuit 303, the D-type flip-flop 304, the buffer 305 and the selector 306, can be realized as a semiconductor device.

As described above, in an arbiter device for a multi-port memory according to aspects of the present invention, when an input address to a first port and an input address to a second port are identical, the operation of the second port can be stopped, and data on the first port can be selected and output, such that simultaneous accesses to the same address can be made.

While the present invention has been described in terms of certain preferred embodiments, those of ordinary skill in the will appreciate that certain variations, extensions and modifications may be made without varying from the basic teachings of the present invention. As such, the present invention is not to be limited to the specific preferred embodiments described herein. Rather, the scope of the present invention is to be determined from the claims, which follow.

What is claimed:

1. An arbiter device for a multi-port memory equipped with a first port and a second port, comprising:
an identical address detection device,
wherein the identical address detection device determines whether an input address to the first port and an input address to the second port are identical;
an operation stopping device,
wherein the operation stopping device stops operation of the second port of the multi-port memory when the identical address detection device determines that the input address to the first port and the input address to the second port are identical; and
a selector device,
wherein the selector device selects data and outputs data on the first port of the multi-port memory when the identical address detection device determines that the input address to the first port and the input address to the second port are identical.

2. An arbiter device according to claim 1, wherein the selector device selects data and outputs data on the second port of the multi-port memory when the identical address detection device determines that the input address to the first port and the input address to the second port are not identical.

3. An arbiter device according to claim 1, wherein identical address detection device is responsive to at least one of the input address to the first port and the input address to the second port.

4. An arbiter device according to claim 1, wherein identical address detection device is adapted to generate an identical address detection signal if the input address to the first port and the input address to the second port are identical.

5. An arbiter device according to claim 1, wherein the selector device is responsive to at least one of a data output signal of the first port, a data output signal of the second port, and a buffer output signal.

6. An arbiter device according to claim 1, wherein the selector device is adapted to generate a data output signal.

7. An arbiter device according to claim 1, wherein the arbiter device arbitrates between accesses to the first port and the second port.

8. An arbiter device for a multi-port memory equipped with a write-only first port and a read-only second port, comprising:
an identical address detection device,
wherein the identical address detection device determines whether an input address to the write-only first port and an input address to the read-only second port are identical;
an operation stopping device,
wherein the operation stopping device stops operation of the read-only second port of the multi-port memory when the identical address detection device determines that the input address to the write-only first port and the input address to the read-only second port are identical; and
a selector device,
wherein the selector device selects data and outputs data on the write-only first port of the multi-port memory when the identical address detection device determines that the input address to the write-only first port and the input address to the read-only second port are identical.

9. An arbiter device according to claim 8, wherein the selector device selects data and outputs data on the read-only second port of the multi-port memory when the identical address detection device determines that the input address to the write-only first port and the input address to the read-only second port are not identical.

10. An arbiter device according to claim 8, wherein identical address detection device is responsive to at least one of the input address to the write-only first port and the input address to the read-only second port.

11. An arbiter device according to claim 8, wherein identical address detection device is adapted to generate an identical address detection signal if the input address to the write-only first port and the input address to the read-only second port are identical.

12. An arbiter device according to claim 8, wherein the selector device is responsive to at least one of a data output signal of the write-only first port, a data output signal of the read-only second port, and a buffer output signal.

13. An arbiter device according to claim 8, wherein the selector device is adapted to generate a data output signal.

14. An arbiter device according to claim 8, wherein the arbiter device arbitrates between accesses to the write-only first port and the read-only second port.

15. An arbiter device for a multi-port memory equipped with a readable and writeable first port and a read-only second port, comprising:
an identical address detection device,
wherein the identical address detection device determines whether an input address to the readable and writeable first port and an input address to the read-only second port are identical, and a writing operation to the first port is enabled;
an operation stopping device,
wherein the operation stopping device stops operation of the read-only second port of the multi-port memory when the identical address detection device determines that the input address to the readable and writeable first port and the input address to the read-only second port are identical, and a writing operation to the first port is enabled; and
a selector device,
wherein the selector device selects data and outputs data on the readable and writeable first port of the multi-port memory when the identical address detection device determines that the input address to the readable and writeable first port and the input address to the read-only second port are identical, and a writing operation to the first port is enabled.

16. An arbiter device according to claim 15, wherein the selector device selects data and outputs data on the read-only second port of the multi-port memory when the identical address detection device determines that the input address to the readable and writeable first port and the input address to the read-only second port are not identical, and a writing operation to the first port is enabled.

17. An arbiter device according to claim 15, wherein identical address detection device is responsive to at least one of the input address to the readable and writeable first port and the input address to the read-only second port.

18. An arbiter device according to claim 15, wherein identical address detection device is adapted to generate an identical address detection signal if the input address to the readable and writeable first port and the input address to the read-only second port are identical.

19. An arbiter device according to claim 15, wherein the selector device is responsive to at least one of a data output signal of the readable and writeable first port, a data output signal of the read-only second port, and a buffer output signal.

20. An arbiter device according to claim 15, wherein the selector device is adapted to generate a data output signal.

21. An arbiter device according to claim 15, wherein the arbiter device arbitrates between accesses to the readable and writeable first port and the read-only second port.

22. A semiconductor device, comprising:
a multi-port memory equipped with a first port and a second port;
an identical address detection device,
wherein the identical address detection device determines that an input address to the first port and an input address to the second port are identical;
an operation stopping device,
wherein the operation stopping device stops operation of the second port when the identical address detection device detects that the input address to the first port and the input address to the second port are identical; and
a selector device,
wherein the selector device selects data and outputs data on the first port when the identical address detection device determines that the input address to the first port and the input address to the second port are identical.

23. An arbiter device according to claim 22, wherein the selector device selects data and outputs data on the second port when the identical address detection device determines that the input address to the first port and the input address to the second port are not identical.

24. An arbiter device according to claim 22, wherein identical address detection device is responsive to at least one of the input address to the first port and the input address to the second port.

25. An arbiter device according to claim 22, wherein identical address detection device is adapted to generate an identical address detection signal if the input address to the first port and the input address to the second port are identical.

26. An arbiter device according to claim 22, wherein the selector device is responsive to at least one of a data output signal of the first port, a data output signal of the second port, and a buffer output signal.

27. An arbiter device according to claim 22, wherein the selector device is adapted to generate a data output signal.

28. An arbiter device according to claim 22, wherein the arbiter device arbitrates between accesses to the first port and the second port.

29. A semiconductor device, comprising:
a multi-port memory equipped with a write-only first port and a read-only second port;
an identical address detection device,
wherein the identical address detection device determines that an input address to the first port and an input address to the second port are identical;
an operation stopping device,
wherein the operation stopping device stops an operation of the second port when the identical address detection device detects that the input address to the first port and the input address to the second port are identical; and
a selector device,
wherein the selector device selects data and outputs data on the first port when the identical address detection device determines that the input address to the first port and the input address to the second port are identical.

30. An arbiter device according to claim 29, wherein the selector device selects data and outputs data on the second port when the identical address detection device determines that the input address to the first port and the input address to the second port are not identical.

31. An arbiter device according to claim 29, wherein identical address detection device is responsive to at least one of the input address to the first port and the input address to the second port.

32. An arbiter device according to claim 29, wherein identical address detection device is adapted to generate an identical address detection signal if the input address to the first port and the input address to the second port are identical.

33. An arbiter device according to claim 29, wherein the selector device is responsive to at least one of a data output signal of the first port, a data output signal of the second port, and a buffer output signal.

34. An arbiter device according to claim 29, wherein the selector device is adapted to generate a data output signal.

35. An arbiter device according to claim 29, wherein the arbiter device arbitrates between accesses to the first port and the second port.

36. A semiconductor device, comprising:
a multi-port memory equipped with a readable and writeable first port and a read-only second port;
an identical address detection device,
wherein the identical address detection device determines that an input address to the first port and an input address to the second port are identical and a writing operation to the first port is enabled;
an operation stopping device,
wherein the operation stopping device stops an operation of the second port when the identical address detection device detects that the input address to the first port and the input address to the second port are identical and the writing operation to the first port is enabled; and
a selector device,
wherein the selector device selects data and outputs data on the first port when the identical address detection device determines that the input address to the first port and the input address to the second port are identical and the writing operation to the first port is enabled.

37. An arbiter device according to claim 36, wherein the selector device selects data and outputs data on the second port when the identical address detection device determines that the input address to the first port and the input address to the second port are not identical and the writing operation to the first port is enabled.

38. An arbiter device according to claim 36, wherein identical address detection device is responsive to at least one of the input address to the first port and the input address to the second port.

39. An arbiter device according to claim 36, wherein identical address detection device is adapted to generate an identical address detection signal if the input address to the first port and the input address to the second port are identical.

40. An arbiter device according to claim 36, wherein the selector device is responsive to at least one of a data output signal of the first port, a data output signal of the second port, and a buffer output signal.

41. An arbiter device according to claim 36, wherein the selector device is adapted to generate a data output signal.

42. An arbiter device according to claim 36, wherein the arbiter device arbitrates between accesses to the first port and the second port.
